(19) United States
(12) Patent Application Publication
(10) Pub. No.: US 2016/0304365 A1
(43) Pub. Date: Oct. 20, 2016

(54) Electrolytic chlorinator

(71) Applicant: Astral Pool Australia Pty Ltd, Noble Park VIC (AU)

(72) Inventor: Aaron Marshall, Noble Park (AU)

(73) Assignee: Astral Pool Australia Pty Ltd

(21) Appl. No.: 15/097,413

(22) Filed: Apr. 13, 2016

(30) Foreign Application Priority Data
Apr. 17, 2015 (AU) 2015901376

(51) Int. Cl. C02F 1/467; C02F 1/461

(52) U.S. Cl. CPC C02F 1/4674; C02F 1/46104; C02F 2103/42

(57) ABSTRACT

An electrolytic chlorinator including a housing, electrodes, and a conduit. The housing defines a flow path for conveying water. The electrodes have a surface area within an interior of the housing to treat the conveyed water. The conduit includes an inlet opening, to the interior of the housing, at a location above at least a majority of the surface area to collect gas resultant from the treatment.

### CROSS-REFERENCE TO RELATED APPLICATIONS

This application is based on and claims the benefit of, and priority from, Australian application 2015901376 filed Apr. 17, 2015, the contents of which are incorporated herein by referenced.

### FIELD

The invention relates to electrolytic chlorinators.

### BACKGROUND

Many swimming pool installations incorporate an electrolytic chlorinator to treat the swimming pool water. Typically, the chlorinator is connected in series with the pool pump so that water is pumped through the chlorinator. The chlorinator includes electrodes energisable to treat the swimming pool water by the electrolytic production of “sanitiser”.

Early electrolytic chlorinators were dangerous. Electrolysis of water produces the explosive combination of hydrogen and oxygen gases. In early electrolytic chlorinators, if the swimming pool pump were to fail, dangerous volumes of this explosive mix could accumulate.

To address this danger, industry practice is to install the chlorinator as part of an inverted U-shaped arrangement which functions as a gas trap. Trapping the gas in this way allows for sensors to be installed to sense the accumulated gas so that suitable interlocks can deactivate the electrodes. It also provides a further backup in that, if the interlock fails, ongoing electrolysis will result in the electrodes being fully immersed in the gaseous mix, so that no more gas is produced.

Whilst electrolytic chlorinators have been around for decades, the present inventors have recognised that existing chlorinators are less than perfect. False “no flow alarms” originating from the mentioned gas sensor are not uncommon. The present inventors have also recognised that, in recent years, no flow alarms have become more common and electrolytic chlorinators seem to be less efficient than they used to be.

It is not admitted that any of the information in this patent specification is common general knowledge, or that the person skilled in the art could be reasonably expected to ascertain or understand it, regard it as relevant or combine it in any way before the priority date.

### SUMMARY

In recent years, “variable speed” swimming pool pumps have become popular in the market. The present inventors have recognised that the increase in false no flow alarms and the apparent reduction in efficiency of electrolytic chlorinators is related to the adoption of these new swimming pool pumps. That said, to emphasise, and as will be apparent from the following discussion, the invention is not limited to the context of variable speed pumps and may be advantageously applied in other contexts.

In years gone by, swimming pool pumps were configured to deliver a relatively high flow rate when active, say about 500 litres per minute, and the time averaged output of the pump was varied to suit the treatment requirements of the pool by varying the pump's duty cycle (i.e. by varying the portion of the day in which the pump was active). Variable speed pumps can be operated for a longer duty cycle, or even continuously, but at a reduced flow rate which is more energy efficient. Variable speed pumps are now often operated at flow rates as low as 120 litres per minute.

The present inventors have recognised that, at these lower flow rates, gas can accumulate within the housing of the electrolytic chlorinator. The accumulated gas shields a portion of the surface area of the electrodes, thereby reducing the efficiency of the chlorinator, and if sufficient volumes of gas are allowed to accumulate can trigger a no flow alarm.

One aspect of the invention provides an electrolytic chlorinator including

a housing defining a flow path for conveying water;

electrodes having a surface area within an interior of the housing to treat the conveyed water; and

a conduit including an inlet opening, to the interior of the housing, at a location above at least a majority of the surface area to collect gas resultant from the treatment.

Preferably an outlet of the conduit is arranged to open, to the conveyed water downstream of the electrodes, at a location at which the conveyed water is at a pressure a pressure difference below a pressure of the conveyed water in the vicinity of the inlet, such that the collected gas is driven from the inlet to the outlet by the pressure difference.

The housing may include an outlet through which the conduit and at least a majority of the conveyed water pass.

The housing may include

an inlet through which at least a majority of the conveyed water enters the housing; and

an or the outlet through which at least a majority of the conveyed water passes.

Preferably the inlet of the housing and the outlet of the housing are below the surface area.

Preferably at least a majority of an interior of the conduit has a cross-sectional area less than 40 mm². It is also preferred that at least a majority of an interior of the conduit has a cross-sectional area greater than 20 mm².

Another aspect of the invention provides a system, for treating swimming pool water, including

the chlorinator; and

a pump for moving the conveyed water.

Another aspect of the invention provides a swimming pool including the system.

Another aspect of the invention provides the use of the chlorinator to treat water of a swimming pool.

Another aspect of the invention provides a method of treating water of a swimming pool; the method including moving the water through an electrolytic chlorinator; the electrolytic chlorinator including
a housing defining a flow path for conveying water;
electrodes having a surface area within an interior of the housing to treat the conveyed water; and
a conduit including an inlet opening, to the interior of the housing, at a location above at least a majority of the surface area to collect gas resultant from the treatment.

### BRIEF DESCRIPTION OF DRAWINGS

FIG. 1 is an end view of an electrolytic chlorinator.

FIG. 2 is a cross-section view corresponding to the line A-A in FIG. 1.

FIG. 3 is a perspective view of an electrode holder.

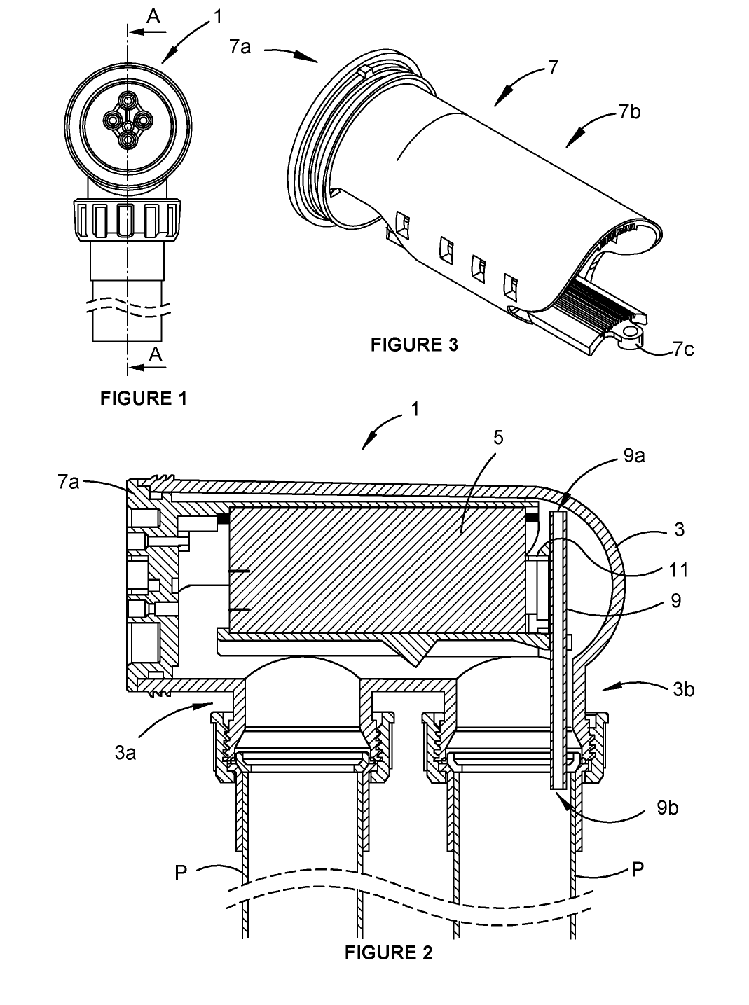

### DESCRIPTION OF EMBODIMENTS

The chlorinator 1 includes a housing 3 housing electrodes 5. The housing is a hollow body including a main body portion in the form of a horizontal cylinder, in which the electrodes 5 are housed, closed at one end by a domed end portion of the housing body and at the other end by an end portion 7a of an electrode holder 7.

The housing 3 includes an inlet 3a for receiving water and an outlet 3b through which water exits the housing. The housing defines a flow path along which water can be moved past the electrodes, such that the electrodes are brought into intimate contact with the water to treat the water.

The inlet 3a and the outlet 3b are each equipped with suitable fittings to sealingly engage plumbing via which the chlorinator 1 may be plumbed into the fluid circuit of a system for treating the water of a swimming pool. A typical treatment system will include a pump, a filter and a chlorinator connected in series with the swimming pool so that the pump circulates the swimming pool water.

When the chlorinator is installed, the electrodes 5 are positioned in an upper portion of a U-shaped gas trap, defined by the housing 3 and the plumbing P, in case the pump fails. To address the problem of gas accumulating whilst water is flowing, the chlorinator 1 includes a conduit 9 for extracting the gas from the housing 3. The inlet 9a of the conduit 9 is positioned in proximity to the top of the electrodes and the top of an interior of the housing 3, i.e. above the vast majority of the surface area of the electrodes within the interior of the housing. The surface area of the electrodes within the housing 3 is the potentially effective surface area, because it is this surface area which can act on the water to treat the water, although a portion of that area may become ineffective if a significant volume of gas were allowed to accumulate.

Various examples of the chlorinator 1 are contemplated. Potentially the conduit 9 could be connected to a dedicated gas pump controlled to collect and dispose of any gas produced by the electrodes. Whilst a dedicated gas pump might be employed, the figures illustrate a preferred arrangement that does away with the need for a dedicated pump. According to this arrangement, the outlet 9b is open to the conveyed water at a location downstream of the electrodes at which the conveyed water is at a pressure lower than the pressure of the water in the vicinity of the inlet 9a.

In this example, the pressure difference arises due to the water accelerating to pass through the outlet 3b which takes the form of a conduit having a cross-sectional area significantly smaller than the cross-sectional area of the housing 3a in the vicinity of the electrodes 5. In this example, the outlet 3b is cylindrical and has a diameter and the outlet 9b is positioned about that diameter from the main body of the housing 3. Experimentation has shown that this distance is sufficient to reliably collect gas bubbles and ensure that those bubbles are carried downwardly away from the housing 3 when they emerge from the outlet 9b. Of course, it is possible that the outlet conduit (potentially including a portion of the plumbing P) has a cross-section other than circular, in which case the preferred distance of the outlet 9b from the main body of the housing 3 can be expressed in terms of about 1.1 times the square root of the cross-sectional area of the outlet conduit.

In this example of the chlorinator, the conduit 9 is about 140 mm long.

The diameter of the conduit 9 has also been found to influence the gas removal efficacy of the conduit 9. On the one hand, too small a tube allows some gas to accumulate within the housing 3. On the other hand, too large a diameter results in larger bubbles of gas emerging from the outlet 9b, with greater potential to resist the downward flow through the outlet 3b and rise back up into the main body of the housing 3. An internal diameter of about 5.4 mm, corresponding to a cross-sectional area in the range of 20 mm² to 40 mm² has been found to deliver satisfactory results. The conduit 9 need not be cylindrical.

The electrode holder 7 is an integral body of plastic, an end portion 7a of which has a stepped, revolved profile. The end portion 7a sealingly engages the housing 3 to close the open end of the housing body. A tubular portion 7b extends away from the end portion 7a to extend into the housing 3. The portion 7b defines two sets of grooves respectively mounted at the top and bottom of its interior and in opposition to each other.

The electrodes 5 take the form of vertical, rectangular, planar plates, the top and bottom edges of which are received within these grooves so that the electrodes are aligned in register with each other, mutually parallel and mutually spaced. The portion 7b is punctuated by openings to allow the conveyed water to travel through the gaps between the spaced electrodes. A portion 7c projects from the end of the portion 7b and defines a vertical aperture for holding the conduit 9.

The holder 7 is fitted with an end clip 11 equipped with a set of grooves into which the vertical end edges of the electrodes are received. The end clip 11 is illustrated in cross-section in FIG. 2. Its upper extent is well below the top of the electrodes so as not to impede the flow of bubbles from the electrodes 5 to the inlet 9a.

The end portion 7a is penetrated by a variety of openings via which a gas sensor, for triggering a no flow alarm, accesses an interior of the housing 3 and by which conductors connect with the electrodes to energise the electrodes.

While the above description refers to one embodiment, it will be appreciated that other embodiments can be adopted by way of different combinations of features. Such embodiments fall within the spirit and scope of this invention.

1. An electrolytic chlorinator including
a housing defining a flow path for conveying water;
electrodes having a surface area within an interior of the housing to treat the conveyed water; and
a conduit including an inlet opening, to the interior of the housing, at a location above at least a majority of the surface area to collect gas resultant from the treatment.

2. The chlorinator of claim 1 wherein an outlet of the conduit is arranged to open, to the conveyed water downstream of the electrodes, at a location at which the conveyed water is at a pressure a pressure difference below a pressure of the conveyed water in the vicinity of the inlet, such that the collected gas is driven from the inlet to the outlet by the pressure difference.

3. The chlorinator of claim 2 wherein the housing includes an outlet through which the conduit and at least a majority of the conveyed water pass.

4. The chlorinator of claim 2 wherein the housing includes
an inlet through which at least a majority of the conveyed water enters the housing; and
an or the outlet through which at least a majority of the conveyed water passes;
the inlet of the housing and the outlet of the housing being below the surface area.

5. The chlorinator of claim 2 wherein at least a majority of an interior of the conduit has a cross-sectional area less than 40 mm².

6. The chlorinator of claim 2 wherein at least a majority of an interior of the conduit has a cross-sectional area greater than 20 mm².

7. A system, for treating swimming pool water, including
a chlorinator including
a housing defining a flow path for conveying water;
electrodes having a surface area within an interior of the housing to treat the conveyed water; and
a conduit including an inlet opening, to the interior of the housing, at a location above at least a majority of the surface area to collect gas resultant from the treatment; and
a pump for moving the conveyed water.

8. The system of claim 7 wherein an outlet of the conduit is arranged to open, to the conveyed water downstream of the electrodes, at a location at which the conveyed water is at a pressure a pressure difference below a pressure of the conveyed water in the vicinity of the inlet, such that the collected gas is driven from the inlet to the outlet by the pressure difference.

9. The system of claim 8 wherein the housing includes an outlet through which the conduit and at least a majority of the conveyed water pass.

10. A swimming pool including a system for treating swimming pool water;
the system including
a housing defining a flow path for conveying water;
electrodes having a surface area within an interior of the housing to treat the conveyed water; and
a conduit including an inlet opening, to the interior of the housing, at a location above at least a majority of the surface area to collect gas resultant from the treatment; and
a pump for moving the conveyed water.

11. The pool of claim 10 wherein an outlet of the conduit is arranged to open, to the conveyed water downstream of the electrodes, at a location at which the conveyed water is at a pressure a pressure difference below a pressure of the conveyed water in the vicinity of the inlet, such that the collected gas is driven from the inlet to the outlet by the pressure difference.

12. The pool of claim 11 wherein the housing includes an outlet through which the conduit and at least a majority of the conveyed water pass.

13. A method of treating water of a swimming pool;
the method including moving the water through an electrolytic chlorinator;
the electrolytic chlorinator including
a housing defining a flow path for conveying water;
electrodes having a surface area within an interior of the housing to treat the conveyed water; and
a conduit including an inlet opening, to the interior of the housing, at a location above at least a majority of the surface area to collect gas resultant from the treatment.

14. The method of claim 13 wherein an outlet of the conduit is arranged to open, to the conveyed water downstream of the electrodes, at a location at which the conveyed water is at a pressure a pressure difference below a pressure of the conveyed water in the vicinity of the inlet, such that the collected gas is driven from the inlet to the outlet by the pressure difference.

15. The method of claim 13 wherein the housing includes an outlet through which the conduit and at least a majority of the conveyed water pass.
